(19) United States
(12) Patent Application Publication
(10) Pub. No.: US 2022/0154687 A1
(43) Pub. Date: May 19, 2022

(54) ROTOR HUB FOR A WIND POWER INSTALLATION, AND CORRESPONDING ROTOR ARRANGEMENT AND WIND POWER INSTALLATION

(71) Applicant: Wobben Properties GmbH, Aurich (DE)

(72) Inventors: Jörg Schüller, Bremen (DE); Florian Sartorius, Leer (DE); Wilko Gudewer, Norden (DE)

(21) Appl. No.: 17/525,457

(22) Filed: Nov. 12, 2021

(30) Foreign Application Priority Data
Nov. 13, 2020 (DE) 102020130066.2

(51) Int. Cl. F03D 1/06; F03D 9/25; F03D 80/70; F03D 80/80

(52) U.S. Cl. CPC F03D 1/0691; F03D 9/25; F03D 80/70; F05B 2260/30; F05B 2240/14; F05B 2220/7066; F03D 80/82

(57) ABSTRACT

A rotor hub for a wind power installation, with at least two flange portions each for receiving a rotor blade, wherein the rotor hub has a housing with a wall which is interrupted by the flange portions, wherein the housing has a wall region between two adjacent flange portions. A rotor arrangement for a wind power installation, and a wind power installation. A surface portion with cylindrical curvature is formed in the wall region.

### BACKGROUND

### Technical Field

The invention concerns a rotor hub for a wind power installation.

### Description of the Related Art

In the priority German application, the German Patent and Trademark Office searched the following documents: U.S. Pat. No. 7,614,850 B2, US 2013/0 202 448 A1, US 2015/0 337 796 A1, EP 3 492 734 B1, EP 2 947 316A1, EP 3 453 871A1

A rotor hub of the type cited initially is known for example from wind power installations. Such wind power installations have a tower, a nacelle, a generator and a rotor hub connected to the generator. The rotor hub is connected to a plurality of rotor blades, wherein each rotor blade is arranged by means of a blade bearing on a flange portion of the rotor hub.

Such blade bearings have a bearing outer ring which is connected by means of a screw connection to the flange portion of the rotor hub, and a bearing inner ring which is connected to the respective rotor blade. In additions, blade bearings are known in which a bearing outer ring is connected to a respective rotor blade and the bearing inner ring is connected to the rotor hub. Rotor hubs previously known from the prior art usually have a part-spherical geometry which is interrupted by the flange portions.

Because of the lever arm between the bolt connections of the bearing outer ring and the part-spherical rotor hub surface, or between the bearing outer ring and bearing inner ring, during operation of the wind power installation so-called carding moments occur which lead to a bending of the flange portion and circumferential hoop stresses in the bearing outer ring of the blade bearing. To avoid fatigue cracks at the bores of the bearing outer ring, it is known from the prior art to reinforce the wall thicknesses of the rotor hub and/or a so-called bulkhead which is arranged in the interior of the flange portions. These reinforcements are also known as thickenings.

In preferred embodiments, the bulkhead is for example cast on or attached to the rotor hub by means of screw connections.

Although the described solution satisfactorily prevents the occurrence of fatigue cracks at the bores of the bearing outer ring, such a design increases the mass of the hub. This mass increase hinders installation of the hub as a whole, increases the material costs and may have a disadvantageous effect with respect to inertia moments.

### BRIEF SUMMARY

The invention concerns a rotor hub for a wind power installation, with at least two flange portions each for receiving a rotor blade, wherein the rotor hub has a housing with a wall which is interrupted by the flange portions, wherein the housing has a wall region between two adjacent flange portions. Provided is a rotor hub for a wind power installation in which the occurrence of fatigue cracks at the bores of the bearing outer ring is prevented in targeted fashion, and at the same time the mass of the rotor hub is reduced.

Provided is a rotor hub of the type cited initially in that a surface portion with cylindrical curvature is formed in the wall region.

The disclosure is based on the approach that the introduction of a cylindrically curved portion between the adjacent flange portions creates a form deviation relative to the typically (part-) spherical hub housings of the prior art. A cylindrically curved portion means a surface portion in which all points on the surface of the portion have the same distance from a theoretical cylinder axis, i.e., lie on a cylinder casing surface. It is not necessary for the cylindrically curved portion to form a fully encased cylinder.

In the prior art, the geometry of the housings—as explained above—was as close as possible to that of a partial sphere, in order to achieve a supposedly optimal load distribution. In the housing regions in which now, according to the invention, a cylindrical housing structure is present in portions, a flattening occurs relative to the ideal spherical geometry known from the prior art, so as to cause a reduction in the lever arm between the fixing bolts of the bearing outer ring and the housing surface of the rotor hub (wherein the lever arm is viewed perpendicularly to the bearing outer ring). In this way, the circumferential hoop stresses in the bearing outer ring are reduced. The advantage here is that the wall of the rotor hub and the bulkhead may be formed without thickenings. As a result, the total mass of the rotor hub may be reduced.

According to a preferred embodiment, the rotor hub has three flange portions, wherein a surface portion with cylindrical curvature is formed between each two adjacent flange portions. In this way, the lever arms between the bearing fixing bolts of the bearing outer rings and the hub surface can be reduced at all blade connections to the rotor hub, and the total mass of the rotor hub can be lowered.

Furthermore, preferably, the surface portion with cylindrical curvature is formed in the region between two adjacent flange portions at which peripheries of the adjacent flange portions have the smallest mutual distance. Preferably, the flattened wall region takes up the greatest surface region relative to a total area between two adjacent flange portions. Forming the flattened wall regions in the region between two adjacent flange portions at which the peripheries of the adjacent flange portions have the smallest mutual distance, has proved advantageous for a particularly targeted reduction of the lever arm between the bearing fixing bolts of the bearing outer ring and the surface of the rotor hub.

According to a second aspect, which is also an advantageous refinement of the first aspect, it is proposed that the housing of the rotor hub adjacent to the wall region has one or more flat wall regions which in particular are formed from at least one polygonal, in particular triangular base surface.

A flat wall region means in this case a wall region which has no technically intentional curvature, i.e., no intended protrusions and depressions beyond general surface unevennesses caused by production or handling or production tolerances.

In the prior art, the geometry of the housings—as explained above—was as close as possible to that of a partial sphere. In the housing regions in which now, flat wall regions are present, a flattening exists relative to the ideal spherical geometry known from the prior art, in the sense of the plane which is preferably formed by at least one polygonal, in particular triangular base surface. Such flat wall regions have proved advantageous for optimizing the development of forces and moments within the rotor hub.

The advantages and preferred embodiments of the second aspect are also advantages and preferred embodiments of the first aspect and vice versa, so to avoid repetition, reference is made to the above statements relating to the first aspect. Both aspects can be furthermore refined in that the housing of the rotor hub adjacent to the flat wall regions has free-form wall regions. These free-form regions have also proved advantageous with respect to optimizing the development of forces and moments within the rotor hub.

According to a preferred embodiment, the free-form wall regions are formed curved. Furthermore, preferably, adjacent wall regions transform into one another without kinks. In this way, not only is the flow of forces and moments within the rotor hub optimized but also the aerodynamic properties are optimized, i.e., in particular the flow resistance is reduced.

Preferably, the surface portions with cylindrical curvature are formed between all pairs of two flange portions. In this way, for all blade bearings, the lever arm between the bearing fixing bolts of the bearing outer ring and the rotor hub surface can be reduced, and hence fatigue cracks at the bores of the bearing fixing bolts can be prevented.

According to a third aspect, or an advantageous refinement according to the first aspect, it is proposed that on at least one flange portion, preferably on several or all flange portions, a collar is formed which extends radially outwardly with respect to a rotational axis of the rotor hub, wherein the collar is configured to increase the stiffness of the collar against carding moments. Such a collar may be used alternatively or additionally to the flattened wall regions in order to increase the stiffness of the collar against carding moments, and to avoid fatigue cracks at the bores for receiving the bearing fixing bolts on the bearing outer ring. By means of the collar, it is achieved that circumferential hoop stresses in the bearing outer ring are introduced into the rotor hub such that the occurrence of fatigue cracks at the bores for receiving the bearing fixing bolts is prevented.

The advantages and preferred embodiments of the third aspect are also advantages and preferred embodiments of the first aspect and/or second aspect and vice versa, so to avoid repetition, reference is made to the above statements relative to the first and/or second aspect.

According to a preferred refinement, the collar is attached to the rotor hub by means of a screw connection. The provision of such a screw connection in principle allows later fitting of such a collar on existing rotor hubs, and has also proved particularly suitable for mounting the collar in a user-friendly fashion.

According to an alternative embodiment, the collar is formed integrally with the rotor hub, in particular is cast thereon. Here, the provision of a collar is taken into account directly on new production of a rotor hub, preventing additional mounting complexity from bolting on a collar and avoiding the introduction of additional bores and screw connections which could weaken the integrity of the rotor hub.

The invention has been described above with reference to a rotor hub. In a further aspect, provided is a rotor arrangement for a wind power installation, with a rotor hub and rotor blades which are arranged on the rotor hub, wherein the rotor blades are adjustable in their angle of attack and are received on flange portions of the rotor hub by means of a respective blade bearing.

The rotor arrangement in that the rotor hub is configured as described according to any of the preceding exemplary embodiments. The rotor arrangement has the same advantages and preferred embodiments as the rotor hub according to the invention. In this respect, reference is made to the above statements and their content is hereby included.

In a further aspect, provided is a wind power installation with a tower on which a nacelle is mounted by means of a rotary connection, a generator received in the nacelle and a rotor arrangement connected to the generator for driving the generator.

The wind power installation in that the rotor arrangement is configured as described according to the preceding exemplary embodiment. The wind power installation has the same advantages and preferred embodiments as the rotor arrangement according to the invention and the rotor hub according to the invention. In this respect, reference is made to the above statements and their content is hereby included.

### BRIEF DESCRIPTION OF THE SEVERAL VIEWS OF THE DRAWINGS

The invention is described below with reference to the appended figures showing preferred exemplary embodiments. The drawings show:

FIG. 1 shows a wind power installation according to a preferred exemplary embodiment;

FIG. 2 shows a rotor hub a for a wind power installation, in a perspective view;

FIG. 3 shows the rotor hub from FIG. 2, in an alternative perspective view;

FIG. 4 shows the rotor hub from FIGS. 2 and 3, in a partially sectional, perspective view;

FIG. 5 shows the rotor hub from FIGS. 2 to 4, and a blade bearing attached to the rotor hub, in a sectional view;

FIG. 6 shows an alternative exemplary embodiment of a rotor hub in a sectional view.

### DETAILED DESCRIPTION

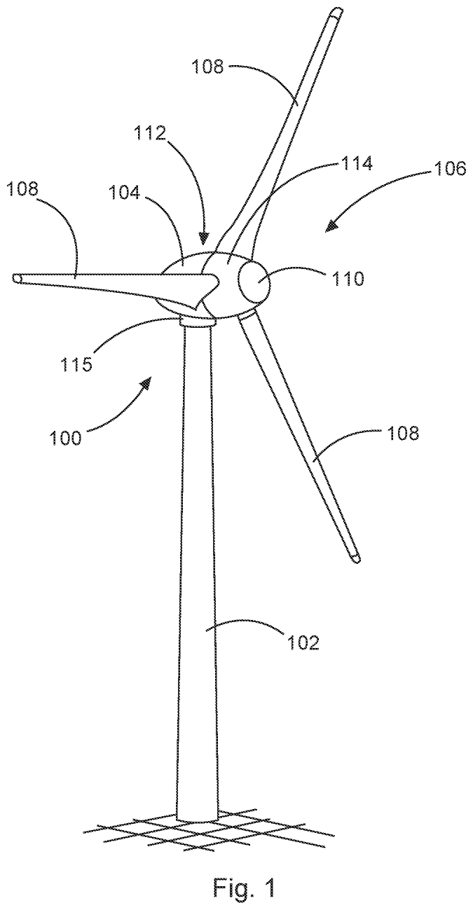

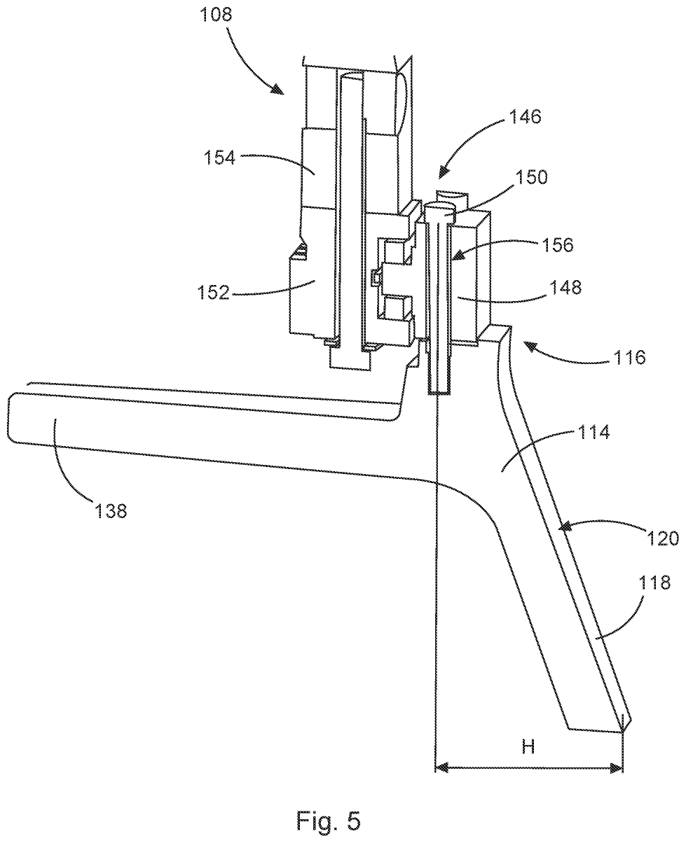

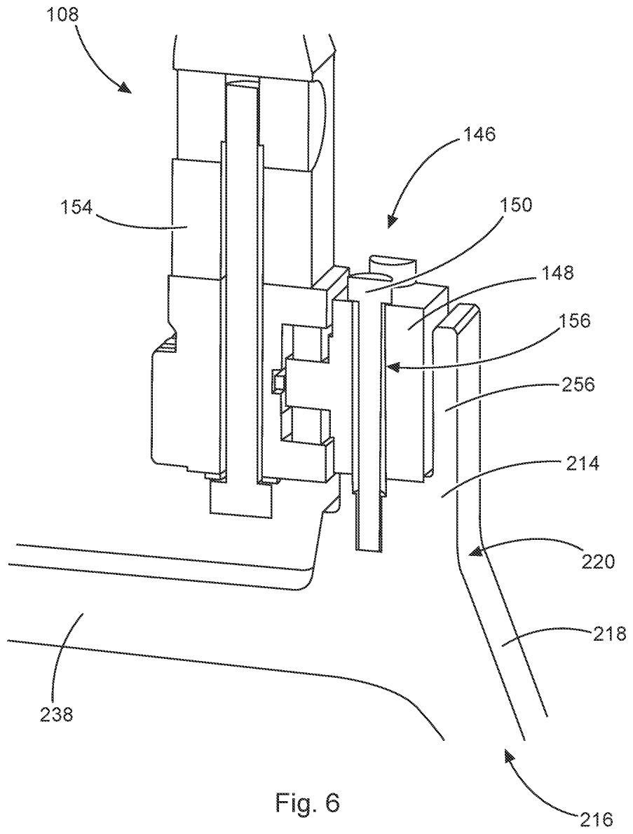

FIG. 1 shows a wind power installation 100 with a tower 102 on which a nacelle 104 is mounted by means of a rotary connection 115. A generator 112 (indicated merely schematically in the figure) is received in the nacelle 104. A rotor arrangement 106 is rotationally connected to the generator 112 for driving the generator 112. The rotor arrangement 106 has a rotor hub 114 and rotor blades 108. The rotor blades 108 are adjustable in their angle of attack and are received on the rotor hub 114 by means of a respective blade bearing 146 (see FIGS. 5 and 6, not shown here). A spinner 110 is arranged on the side of the rotor hub 114 facing away from the generator 112. The rotor arrangement 106 drives the generator 112 in order to generate electrical current.

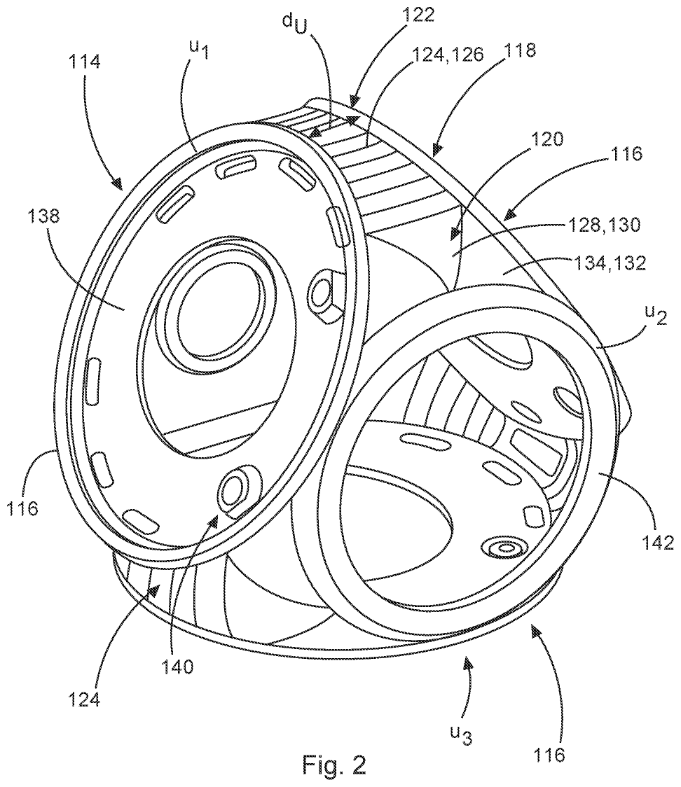

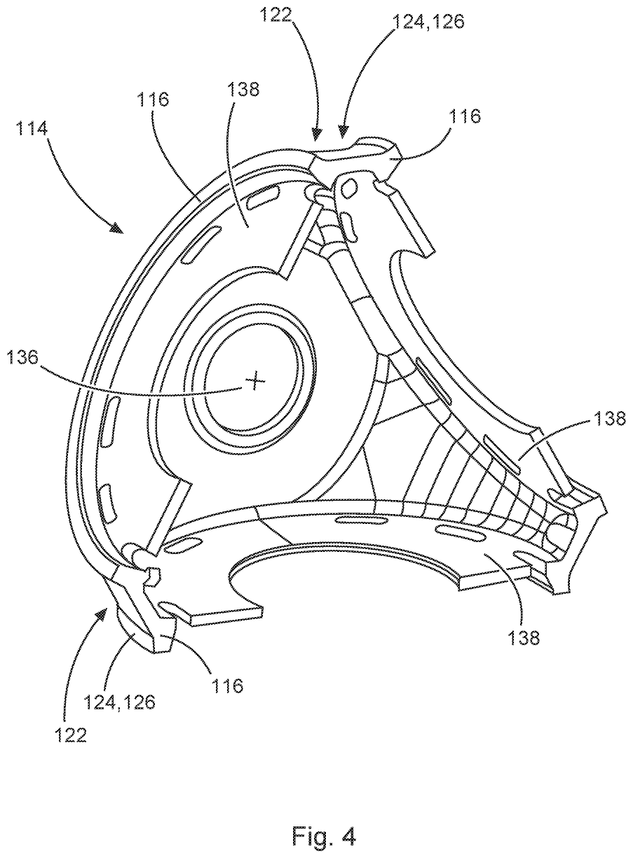

The rotor hub 114 is illustrated in FIGS. 2-5 and is described initially with reference to FIG. 2. The rotor hub 114 has a housing 118 with a wall 120. The wall 120 is interrupted by flange portions 116. The housing 118 has a wall region 122 between two adjacent flange portions 116. A surface portion 124 with cylindrical curvature 126 is formed in the wall region 122. The rotor hub 114 has a total of three flange portions 116, wherein a surface portion 124 with cylindrical curvature 126 is formed between each two adjacent flange portions 116. In the exemplary embodiment shown in FIG. 2, such a surface portion 124 with cylindrical curvature 126 is formed between all pairs of two flange portions 116.

The surface portion 124 with cylindrical curvature 126 is arranged in the region between two adjacent flange portions 116 at which peripheries u₁, u₂, u₃ of the adjacent flange portions 116 have the smallest mutual distance dᵤ. The housing 118 of the rotor hub 114 has flat wall regions 128 adjacent to the wall region 122. The flat wall regions 128 are formed from at least one triangular base surface 130. The housing 118 of the rotor hub 114 furthermore comprises free-form wall regions 132 adjacent to the flat wall regions 128. The free-form wall regions 132 are configured curved 134. Adjacent wall regions 122, 128, 130 transform into one another without kinks.

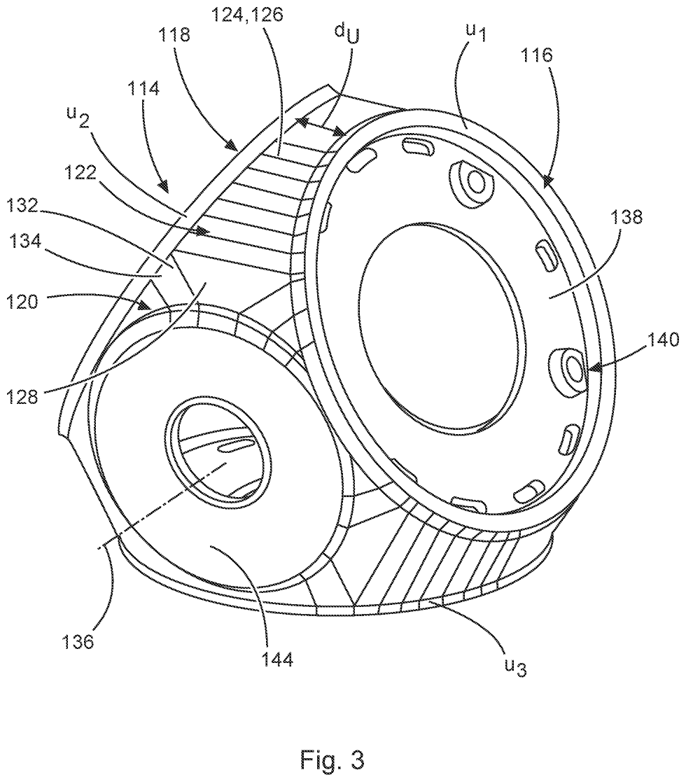

As evident in particular from FIG. 2, the rotor hub 114 has a generator connection flange 142 for connection to a generator. Within the flange portion 116, bulkheads 138 are also formed which reinforce the rotor hub 114, in particular structurally, and provide receivers for actuators 140 (not shown) for the angle of attack of the blades. As evident from FIG. 3, the rotor hub 114 has a rotational axis 136 about which the rotor hub 114 rotates during operation of the wind power installation 100. Furthermore, a spinner connection flange 144, which is configured to receive the spinner 110, is arranged in a region of the rotor hub 114 opposite the generator flange 142.

FIG. 5 shows the rotor hub 114 with blade bearing 146 received at the flange portion 116, by means of which bearing a rotor blade 108 is arranged on the rotor hub 114. The rotor hub 114 comprises the bulkhead 138 and the housing 118 with the wall 120. A bearing outer ring 148 is arranged at the flange portion 116 by means of bearing fixing bolts 150. To receive the bearing fixing bolts 150, the bearing outer ring 148 has bearing bores 156. The bearing outer ring 148 is coupled to a bearing inner ring 152 which is connected to a blade flange 154 via a fixing means. The rotor blade 108 is connected to the bearing inner ring 152 via the blade flange 154.

During operation, a bending of the flange portion 116 of the rotor hub 114 causes high circumferential hoop stresses in the bearing outer ring 148 of the blade bearing 146. In particular, the bearing bore 156 is exposed to such hoop stresses, whereby the bearing bores 156 are susceptible to the formation of fatigue cracks. Because of the flattening of the rotor hub 114 relative to an ideal spherical geometry as known from the prior art, in the present case the lever arm H between the surface of the housing 118 of the rotor hub 114 and the bearing bore 156 of the bearing outer ring 148 or corresponding bearing fixing bolts 150 is reduced, whereby the occurrence of fatigue cracks in the region of the bearing bores 156 of the bearing outer ring 148 is avoided.

FIG. 6 shows an alternative exemplary embodiment of a rotor hub 214. The rotor hub 214 has a bulkhead 238 and a housing 218 with a wall 220. The rotor hub 214 furthermore has a flange portion 216 on which a collar 256 is arranged. In the present FIG. 6, the collar 256 stands in contact with the bearing outer ring 148 of the blade bearing 146, but need not necessarily do so. As in the bearing outer ring 148, carding moments cause circumferential hoop stresses in the collar 256. The circumferential hoop stresses in the collar 256 prevent a deformation of the flange portion 216, which leads to a reduction of the hoop stresses in the bearing outer ring 148. The occurrence of fatigue cracks at the bearing bores 156 is thus avoided.

### LIST OF REFERENCE SIGNS USED

100 Wind power installation
102 Tower
104 Nacelle
106 Rotor arrangement
108 Rotor blade
110 Spinner
112 Generator
114 Rotor hub
115 Rotary connection
116 Flange portion
118 Housing
120 Wall
122 Wall region between two adjacent flange portions
124 Surface portion
126 Cylindrical curvature
128 Flat wall regions
130 Triangular base surfaces
132 Free-form wall region
134 Curvature of free-form wall region
136 Rotational axis of hub
138 Bulkhead
140 Receiver for actuator for blade angle of attack
142 Generator connection flange
144 Spinner connection flange
146 Blade bearing
148 Bearing outer ring
150 Bearing fixing bolts
152 Bearing inner ring
154 Blade flange
156 Bearing bore of bearing outer ring
214 Rotor hub
216 Flange portion
218 Housing
220 Wall
238 Bulkhead
256 Collar
dᵤ Distance of peripheries of flange portions
H Lever arm
u₁, u₂, u₃ Peripheries of flange portions

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A rotor hub for a wind power installation, comprising:
a plurality of flange portions, each flange portion being configured to receive a rotor blade,
a housing having a wall that extends to two of the plurality of the flange portions,
wherein the housing has a wall region between two adjacent flange portions, and
wherein a surface portion with cylindrical curvature is located in the wall region.

2. The rotor hub according to claim 1, wherein the plurality of flange portions are three flange portions, wherein the surface portion with the cylindrical curvature is located between each two adjacent flange portions of the three flange portions.

3. The rotor hub according to claim 1, wherein the surface portion with the cylindrical curvature is located in the region between two adjacent flange portions, wherein peripheries of the two adjacent flange portions have a smallest mutual distance.

4. The rotor hub according to claim 1, wherein the housing adjacent to the wall region has one or more flat wall regions that are formed from at least one triangular base surface.

5. The rotor hub according to claim 4, wherein the housing of the rotor hub adjacent to the flat wall regions has free-form wall regions.

6. The rotor hub according to claim 5, wherein the free-form wall regions are curved.

7. The rotor hub according to claim 1, wherein adjacent wall regions transform into one another without kinks.

8. The rotor hub according to claim 1, comprising a plurality of surface portions with cylindrical curvature located between all pairs of two adjacent flange portions.

9. The rotor hub according to claim 1, wherein a collar is located on at least one flange portion and extends radially outwardly with respect to a rotational axis of the rotor hub, and wherein the collar is configured to increase the stiffness of the collar against carding moments.

10. The rotor hub according to claim 9, wherein the collar is attached to the rotor hub by a screw connection.

11. The rotor hub according to claim 9, wherein the collar is integrally formed with the rotor hub.

12. A rotor arrangement for a wind power installation, comprising:
a rotor hub having:
a plurality of flange portions, each flange portion being configured to receive a rotor blade,
a housing having a wall that extends to two of the plurality of the flange portions,
wherein the housing has a wall region between two adjacent flange portions, and
wherein a surface portion with cylindrical curvature is located in the wall region, and
a plurality of rotor blades on the rotor hub, wherein each of the plurality of rotor blades have an angle of attack that is configured to be adjusted and are received at a respective flange portion of the plurality of flange portions of the rotor hub by a respective blade bearing.

13. A wind power installation comprising:
a tower,
a nacelle mounted on the tower by a rotary connection,
a generator located in the nacelle, and
the rotor arrangement according to claim 12 connected to the generator for driving the generator.
